(19) United States
(12) Patent Application Publication
(10) Pub. No.: US 2016/0261045 A1
(43) Pub. Date: Sep. 8, 2016

(54) MULTI-INPUT MULTI-OUTPUT (MIMO) ANTENNA

(71) Applicant: Arcadyan Technology Corporation, Hsinchu City (TW)

(72) Inventors: Shih-Chieh CHENG, Tainan City (TW); Min-Chi WU, Zhubei City (TW)

(73) Assignee: Arcadyan Technology Corporation, Hsinchu City (TW)

(21) Appl. No.: 15/060,586

(22) Filed: Mar. 3, 2016

(30) Foreign Application Priority Data
Mar. 5, 2015 (TW) 104107005

(51) Int. Cl. H01Q 5/10

(52) U.S. Cl. CPC H01Q 5/10

(57) ABSTRACT

A multi-input multi-output antenna including a substrate, a first multi-band antenna, a second multi-band antenna, and a multi-band filter is provided. The first multi-band antenna includes first and second radiators operated in first and second bands respectively. The second radiator extends from a first terminal of the first radiator and surrounds the first radiator. The operating frequency of the first band is higher than that of the second band. The second multi-band antenna includes third and fourth radiators operated in the first and the second bands respectively. The fourth radiator extends from a second terminal of the third radiator and surrounds the third radiator. The multi-band filter has a first filter part and a second filter part orthogonal to each other. The first filter part and the second filter part filter a first current and a second current respectively.

This application claims the benefit of Taiwan application Serial No. 104107005, filed Mar. 5, 2015, the disclosure of which is incorporated by reference herein in its entirety.

### TECHNICAL FIELD

The disclosure relates in general to a multi-input multi-output antenna, and more particularly to a multi-input multi-output antenna with filter function.

### BACKGROUND

The multi-input multi-output antenna receives/transmits two or more independent data at the same time via one single channel, hence doubling the speed of data transmission.

Since the multi-input multi-output antenna receives/transmits data using multiple antennas at the same time, the signal coupling effect between the antennas needs to be reduced or removed. Otherwise, the signal coupling effect will cause signal distortion or even deteriorate the sensitivity of signal reception.

### SUMMARY

The disclosure is directed to a multi-input multi-output antenna with filter function. A multi-band filter is disposed between two adjacent antennas to reduce the signal coupling effect between the antennas.

In an embodiment of the present disclosure, a multi-input multi-output antenna is provided. The multi-input multi-output antenna includes a substrate, a first multi-band antenna, a second multi-band antenna, and a multi-band filter. The substrate is formed on the substrate and includes a first radiator and a second radiator operated in a first band and a second band, respectively. The second radiator extends from a first terminal of the first radiator and surrounds the first radiator, and the operating frequency of the first band is higher than that of the second band. The second multi-band antenna is formed on the substrate and includes a third radiator and a fourth radiator operated in the first band and the second band, respectively. The fourth radiator extends from a second terminal of the third radiator and surrounds the third radiator. The multi-band filter is formed on the substrate and has a first filter part and a second filter part orthogonal to each other. The first filter part is formed over the substrate and has two corresponding terminals connecting the first multi-band antenna and the second multi-band antenna, respectively. The second filter part is disposed on the substrate. The first filter part having a projection overlapping with the second filter part filters a first current flowing through the first radiator and/or the third radiator. The second filter part filters a second current flowing through the second radiator and/or the fourth radiator.

The first multi-band antenna and the second multi-band antenna may be operated in more bands through the design in which more radiators or radiation slots are incorporated. The multi-band filter is disposed at an electrical connection between the first multi-band antenna and the second multi-band antenna and under a projection of the electrical connection to filter the radiation current generated by the first multi-band antenna and the second multi-band antenna, such that the signal coupling effect generated between the first multi-band antenna and the second multi-band antenna may be reduced or removed.

In the present disclosure, a first feed-in part is disposed near the junction node between the first radiator and the second radiator, and a second feed-in part is disposed near the junction node between the third radiator and the fourth radiator. A third terminal of the first radiator and a fourth terminal of the third radiator are disposed oppositely and are electrically connected to each other through the first filter part. A first ground part is disposed near the third terminal. A second ground part is disposed near the fourth terminal. The first filter part and the second filter part are electrically connected to a ground disposed on the part of the substrate opposite to the projection areas of the first multi-band antenna and the second multi-band antenna.

The above and other contents of the invention will become better understood with regard to the following detailed description of the preferred but non-limiting embodiment(s). The following description is made with reference to the accompanying drawings.

### BRIEF DESCRIPTION OF THE DRAWINGS

FIG. 1A and FIG. 1B are schematic diagrams of a multi-input multi-output antenna according to an embodiment of the present disclosure.

FIG. 2 is a front view of a substrate according to an embodiment of the present disclosure.

FIG. 3A is a back view of an integrally formed metal according to an embodiment of the present disclosure; FIG. 3B is a front view of the integrally formed metal according to the embodiment of the present disclosure; FIG. 3C and FIG. 3D are 3D diagrams of the integrally formed metal according to the embodiment of the present disclosure.

FIG. 4A and FIG. 4B respectively are VSWR diagrams of a first dual-band antenna and a second dual-band antenna according to an embodiment of the present disclosure.

FIG. 4C is a diagram illustrating the degree of isolation between the first dual-band antenna and the second dual-band antenna according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms are used in the specification with reference to generally-known terminologies used in the technology field. For any terms described or defined in the specification, the descriptions and definitions in the specification shall prevail. For any technologies and theories which are commonly seen in the technology field of the present disclosure but not involved with the technical features of the present disclosure, the similarities will not be repeated.

Each embodiment of the present disclosure has one or more technical characteristics. Given that each embodiment is implementable, a person ordinarily skilled in the art may selectively implement or combine some or all of the technical characteristics of any embodiment of the present disclosure.

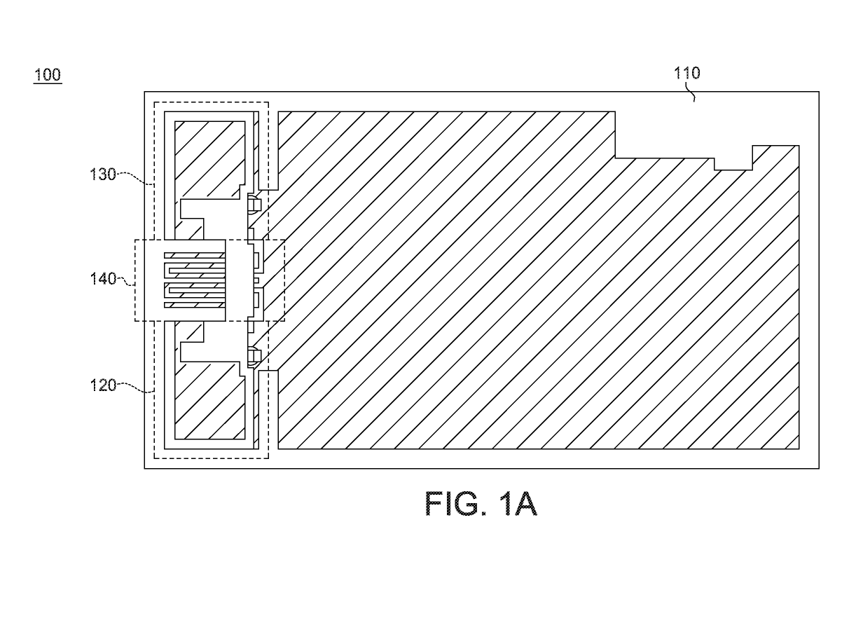

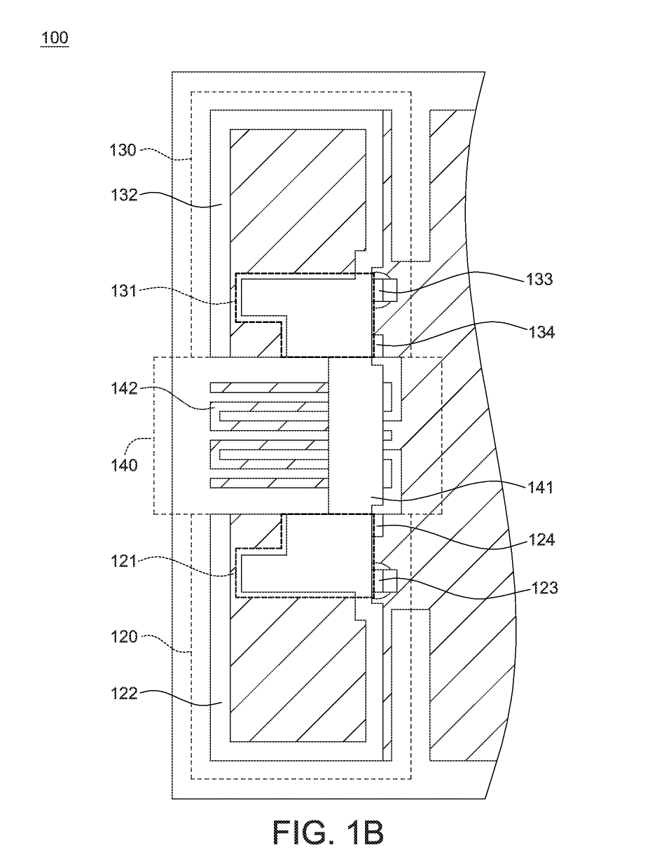

Referring to FIG. 1A and FIG. 1B, schematic diagrams of a multi-input multi-output antenna according to an embodiment of the present disclosure are shown. FIG. 1B is a partial enlargement of FIG. 1A. The multi-input multi-output antenna 100 includes a substrate 110, a first dual-band antenna 120, a second dual-band antenna 130 and a dual-band filter 140.

The substrate 110 may be realized by a printed circuit board (PCB) made of a dielectric material.

Both the first dual-band antenna 120 and the second dual-band antenna 130 may support dual-band (such as the first band 5 GHz and the second band 2.4 GHz). In an embodiment of the present, the first dual-band antenna 120 and the second dual-band antenna 130 are symmetric with respect to each other. In other embodiments of the present disclosure, the first dual-band antenna 120 and the second dual-band antenna 130 are not necessarily symmetric with respect to each other. However, if the first dual-band antenna 120 and the second dual-band antenna 130 are symmetric with respect to each other, a better field pattern is generated. The architectures of the first dual-band antenna 120 and the second dual-band antenna 130 are not subject to specific restrictions.

For convenience of elaboration, the architecture of the first dual-band antenna 120 is elaborated below. The architecture of the second dual-band antenna 130 is similar to that of the first dual-band antenna 120 and thus is not elaborated below. The first dual-band antenna 120 includes a first radiator 121 and a second radiator 122 operated in a first band and a second band, respectively. The second radiator 122 extends from a terminal of the first radiator 121 and surrounds the first radiator 121. The operating frequency of the first band is higher than that of the second band. The first radiator 121 and the second radiator 122 may be made of metal. The second dual-band antenna 130 includes a third radiator 131 and a fourth radiator 132 operated in the first band and the second band, respectively. Likewise, the fourth radiator 132 extends from a terminal third of the radiator 131 and surrounds the third radiator 131.

The first radiator 121 and/or the third radiator 131 may have a stepped shape. In other possible embodiments of the present disclosure, the first radiator 121 and/or the third radiator 131 may have a triangular shape (with an increasing width) or a hooked shape.

The first dual-band antenna 120 further includes a feed-in part 123 and a ground part 124. The second dual-band antenna 130 further includes a feed-in part 133 and a ground part 134.

The dual-band filter 140 includes a metal part 141 and a PCB part 142 which are orthogonal to each other. The metal part 141 is made of metal, and the PCB part 142 is formed of a PCB. As indicated in FIG. 1A and FIG. 1B, the metal part 141 extends along a vertical direction and the PCB part 142 extends along a horizontal direction (i.e. the comb direction of the PCB part 142 is horizontal).

As indicated in FIG. 1A and FIG. 1B, the metal part 141 of the dual-band filter 140 is connected to the first radiator 121 of the first dual-band antenna 120 and the third radiator 131 of the second dual-band antenna 130. The metal part 141 of the dual-band filter 140 is disposed between the first radiator 121 of the first dual-band antenna 120 and the third radiator 131 of the second dual-band antenna 130. The metal part 141 of the dual-band filter 140 filters the first band current. When the first radiator 121 of the first dual-band antenna 120 receives/transmits signals, the metal part 141 of the dual-band filter 140 may filter the 5 GHz current generated on the first radiator 121 of the first dual-band antenna 120 to avoid the current being coupled to the third radiator 131 of the second dual-band antenna 130. Similarly, when the third radiator 131 of the second dual-band antenna 130 receives/transmits signals, the metal part 141 of the dual-band filter 140 may filter the 5 GHz current generated on the third radiator 131 of the second dual-band antenna 130 to avoid the current being coupled to the first radiator 121 of the first dual-band antenna 120.

In an embodiment of the present, if the first radiator 121 of the first dual-band antenna 120 and the third radiator 131 of the second dual-band antenna 130 are operated in a higher band, the metal part 141 of the dual-band filter 140 may be partly hollowed to filter the current of higher frequency. The larger the hollowed area, the higher frequency current may be filtered.

The PCB part 142 of the dual-band filter 140 (disposed on the substrate 110) filters the second band current. The PCB part 142 may be comb-shaped such that the path of the current may be increased, and the second band current may be filtered more effectively. The PCB part 142 of the dual-band filter 140 is disposed between a projection of the first radiator 121 of the first dual-band antenna 120 and a projection of the third radiator 131 of the second dual-band antenna 130, and between a projection of the second radiator 122 of the first dual-band antenna 120 and a projection of the fourth radiator 132 of the second dual-band antenna 130. The metal part 141 (may also be referred as the first filter part) has two corresponding terminals connecting to the first multi-band antenna 120 and the second multi-band antenna 130, respectively. The PCB part 142 (may also be referred as the second filter part) is disposed on the substrate 110. The metal part 141 (also referred as the first filter part) has a projection overlapping with the PCB part 142 (also referred as the second filter part).

When the second radiator 122 of the first dual-band antenna 120 receives/transmits signals, the PCB part 142 of the dual-band filter 140 may filter the 2.4 GHz current generated on the second radiator 122 of the first dual-band antenna 120 to avoid the current being coupled to the fourth radiator 132 of the second dual-band antenna 130. Similarly, when the fourth radiator 132 of the second dual-band antenna 130 receives/transmits signals, the PCB part 142 of the dual-band filter 140 may filter the 2.4 GHz current generated on the fourth radiator 132 of the second dual-band antenna 130 to avoid the current being coupled to the second radiator 122 of the first dual-band antenna 120.

In the light of projection, the projection of the metal part 141 is within the projection of the PCB part 142. Viewing from the vertical direction of the diagram, the metal part 141 partly overlaps but does not contact with the PCB part 142. That is, a space is between the metal part 141 and the PCB part 142.

The dual-band filter 140 is disposed at an electrical connection node between the first multi-band antenna 120 and the second multi-band antenna 130 and is further under a projection of the electrical connection, to filter the radiation current generated by the first multi-band antenna 120 and the second multi-band antenna 130. Therefore, the signal coupling effect between the first multi-band antenna 120 and the second multi-band antenna 130 may be reduced or removed.

In an embodiment of the present, a first feed-in part (the feed-in part 123) is disposed near the junction between the first radiator 121 and the second radiator 122, and a second feed-in part (the feed-in part 133) is disposed near the junction between the third radiator 131 and the fourth radiator 132. A third terminal of the first radiator 121 and a fourth terminal of the second radiator 131 are disposed oppositely and electrically connected to each other. A first ground part 124 is disposed near the third terminal, and a second ground part 134 is disposed near the fourth terminal. The first ground part 124 and the second ground part 134 are connected to the first filter part 141, and the first filter part 141 is electrically connected to ground through the first ground part 124 and the second ground part 134. The second filter part 142 is also electrically connected to the ground.

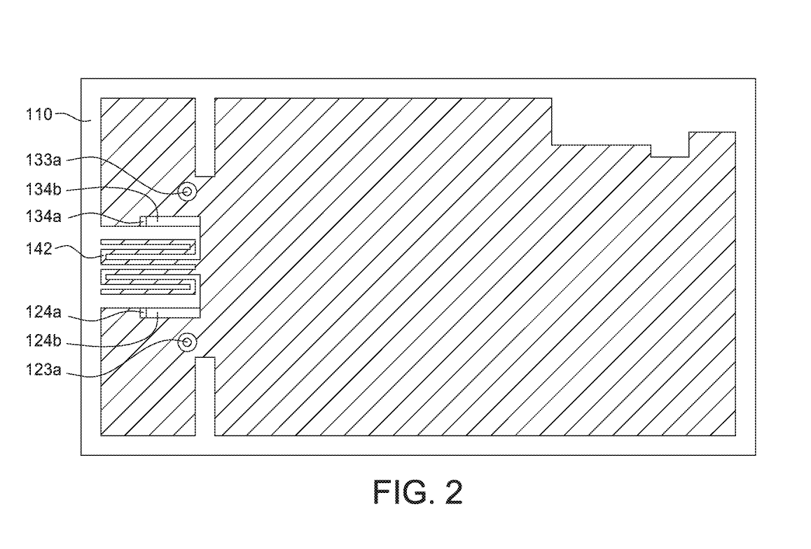

FIG. 2 is a front view of a substrate 110 according to an embodiment of the present disclosure. The shape of the PCB part 142 of the dual-band filter 140 is illustrated in FIG. 2.

As indicated in FIG. 2, a plurality of holes 123a, 124a, 133a and 134a are formed on the substrate 110. The feed-in part 123 of the first dual-band antenna 120 may be inserted into the hole 123a, and signals may be fed to the first dual-band antenna 120 via the substrate 110. The ground part 124 of the first dual-band antenna 120 may be inserted into the hole 124a. Similarly, the feed-in part 133 of the second dual-band antenna 130 may be inserted into the hole 133a, and signals may be fed to the second dual-band antenna 130 via the substrate 110. The ground part 134 of the second dual-band antenna 130 may be inserted into the hole 134a.

The substrate 110 further includes two metal parts 124b and 134b electrically contacting the ground part 124 of the first dual-band antenna 120 and the ground part 134 of the second dual-band antenna 130 respectively to increase the ground effect.

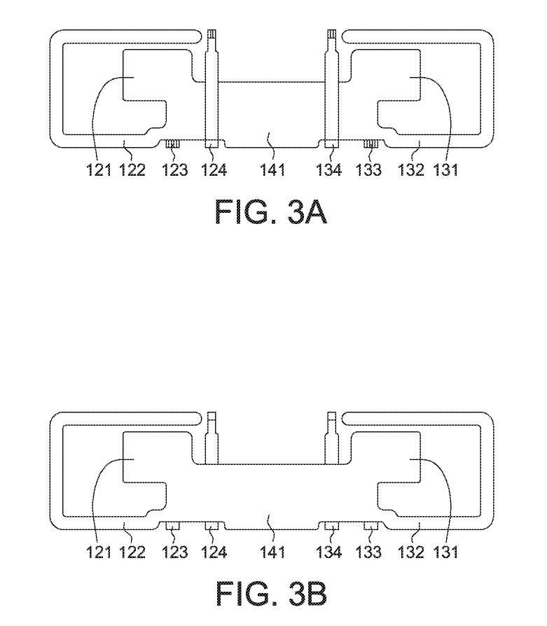

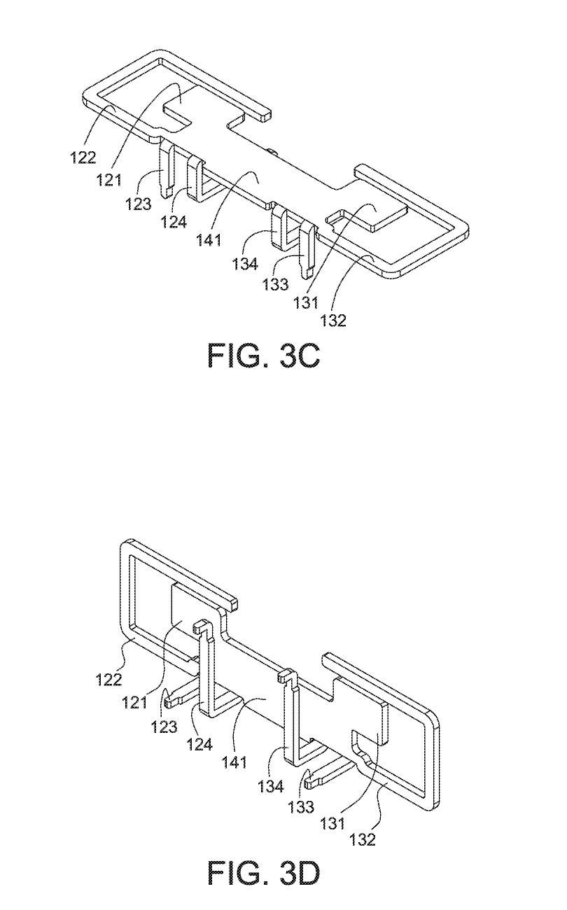

FIG. 3A is a back view of an integrally formed metal according to an embodiment of the present disclosure. FIG. 3B is a front view of the integrally formed metal according to the embodiment of the present disclosure. FIG. 3C and FIG. 3D are 3D diagrams of the integrally formed metal according to the embodiment of the present disclosure.

The integrally formed metal includes the first radiator 121, the second radiator 122, the feed-in part 123 and the ground part 124 of the first dual-band antenna 120, the third radiator 131, the fourth radiator 132, the feed-in part 133 and the ground part 134 of the second dual-band antenna 130, and the metal part 141 of the dual-band filter 140.

As indicated in FIG. 3A˜FIG. 3D, the first radiator 121 and the second radiator 122 of the first dual-band antenna 120, the third radiator 131 and the fourth radiator 132 of the second dual-band antenna 130, and the metal part 141 of the dual-band filter 140 are disposed on the same plane, such that the overall height of the multi-input multi-output antenna 100 may be effectively reduced.

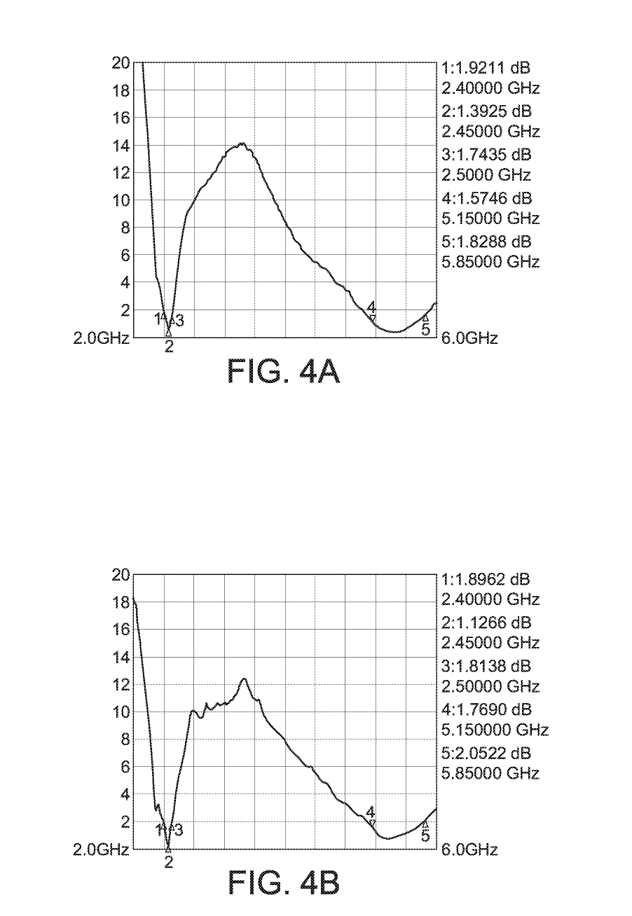

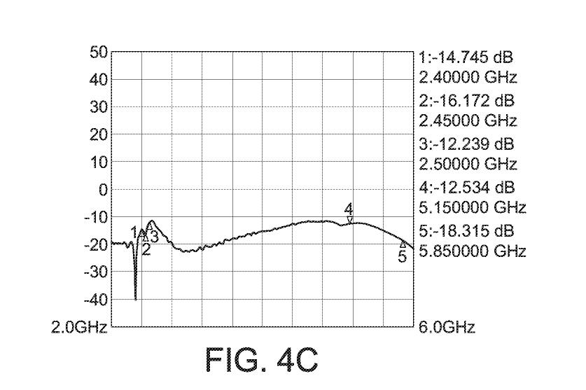

FIG. 4A and FIG. 4B respectively are voltage standing wave ratio (VSWR) diagrams of the first dual-band antenna 120 and the second dual-band antenna 130 according to the embodiment of the present disclosure. As indicated in FIG. 4A and FIG. 4B, the multi-input multi-output antenna of the embodiment of the present disclosure has satisfactory voltage standing wave ratios at the first band (5 GHz) and the second band (2.4 GHz). That is, the dual-band filter of the present disclosure does not significantly affect the antenna gain.

FIG. 4C is a diagram illustrating the degree of isolation between the first dual-band antenna 120 and the second dual-band antenna 130 according to an embodiment of the present disclosure. As indicated in FIG. 4C, the dual-band filter of an embodiment of the present may effectively reduce the signal coupling effect between the antennas 120 and 130 to achieve a high degree of isolation.

An embodiment of the present may further be used in a multi-input multi-output antenna having multiple antennas (for example, more than three antennas), and the dual-band filter is disposed between the antennas.

The antenna of the embodiment of the present disclosure may be used in a high frequency environment. For example, the antenna of the embodiment of the present disclosure may be implemented in a wireless network card, which may be installed or inserted into an internet TV, or a projector having wireless communication function (the projector communicating with a notebook computer via wireless communication to wirelessly receive high-band data transmitted from the notebook computer). Since the multi-input multi-output antenna of the embodiment of the present disclosure has a small size, the electronic products still have small size and simple design.

The dual-band filter of the embodiment of the present disclosure may reduce the signal coupling effect between antennas without significantly affecting the antenna gain of the dual-band filter.

Moreover, the antenna of the embodiment of the present disclosure is omni-directional.

In other possible embodiments of the present disclosure, the first dual-band antenna and the second dual-band antenna may be operated in more bands by incorporating more radiators or radiation slots.

It will be apparent to those skilled in the art that various modifications and variations may be made to the disclosed embodiments. It is intended that the specification and examples be considered as exemplary only, with a true scope of the disclosure being indicated by the following claims and their equivalents.

What is claimed is:

1. A multi-input multi-output antenna, comprising:
a substrate;
a first multi-band antenna formed on the substrate, wherein the first multi-band antenna comprises a first radiator and a second radiator operated in a first band and a second band, respectively, the second radiator extends from a first terminal of the first radiator and surrounds the first radiator, and an operating frequency of the first band is higher than an operating frequency of the second band;
a second multi-band antenna formed on the substrate, wherein the second multi-band antenna comprises a third radiator and a fourth radiator operated in the first band and the second band, respectively, and the fourth radiator extends from a second terminal of the third radiator and surrounds the third radiator; and
a multi-band filter having a first filter part and a second filter part orthogonal to each other, wherein the first filter part is formed over the substrate and has two corresponding terminals respectively connecting to the first multi-band antenna and the second multi-band antenna, the second filter part is disposed on the substrate, the first filter part has a projection overlapping with the second filter part, the first filter part filters a first current flowing through the first radiator and/or the third radiator, and the second filter part filters a second current flowing through the second radiator and/or the fourth radiator.

2. The multi-input multi-output antenna according to claim 1, wherein,
the first filter part is made of metal; and
the second filter part is made of the same material with the substrate and has a comb shape.

3. The multi-input multi-output antenna according to claim 1, wherein,
the first radiator and/or the third radiator has a hooked shape, a triangular shape or a stepped shape.

4. The multi-input multi-output antenna according to claim 1, wherein, the first multi-band antenna and the second multi-band antenna are symmetric with respect to each other.

5. The multi-input multi-output antenna according to claim 1, wherein,
the first filter part of the multi-band filter is connected to the first radiator of the first multi-band antenna and the third radiator of the second multi-band antenna; and
the first filter part of the multi-band filter is disposed between the first radiator of the first multi-band antenna and the third radiator of the second multi-band antenna.

6. The multi-input multi-output antenna according to claim 1, wherein,
the second filter part of the multi-band filter is disposed between a projection of the first radiator of the first multi-band antenna and a projection of the third radiator of the second multi-band antenna; and
the second filter part of the multi-band filter is disposed between a projection of the second radiator of the first multi-band antenna and a projection of the fourth radiator of the second multi-band antenna.

7. The multi-input multi-output antenna according to claim 1, wherein,
the first filter part of the multi-band filter has a projection overlapping with the second filter part of the multi-band filter; and
a space is between the first filter part of the multi-band filter and the second filter part of the multi-band filter.

8. The multi-input multi-output antenna according to claim 1, wherein,
the first multi-band antenna further comprises a first feed-in part and a first ground part;
the second multi-band antenna further comprises a second feed-in part and a second ground part;
a plurality of holes are formed on the substrate, and the first feed-in part and the first ground part of the first multi-band antenna and the second feed-in part and the second ground part of the second multi-band antenna are respectively inserted into the holes; and
the substrate further comprises a plurality of metal parts electrically contacting the first ground part of the first multi-band antenna and the second ground part of the second multi-band antenna, respectively.

9. The multi-input multi-output antenna according to claim 1, wherein,
the first radiator and the second radiator of the first multi-band antenna, the third radiator and the fourth radiator of the second multi-band antenna, and the first filter part of the multi-band filter are integrally formed in one piece and disposed on the same plane.

10. The multi-input multi-output antenna according to claim 1, wherein, the multi-band filter is disposed at an electrical connection node between the first multi-band antenna and the second multi-band antenna and is under a projection of the electrical connection to filter the radiation current generated by the first multi-band antenna and the second multi-band antenna.

11. The multi-input multi-output antenna according to claim 1, wherein,
a first feed-in part is disposed near a junction between the first radiator and the second radiator,
a second feed-in part is disposed near a junction between the third radiator and the fourth radiator,
a third terminal of the first radiator and a fourth terminal of the third radiator are disposed oppositely and electrically connected to each other,
a first ground part is disposed near the third terminal,
a second ground part is disposed near the fourth terminal, and
the first filter part and the second filter part are electrically connected to a ground.
